(19) United States
(12) Patent Application Publication
(10) Pub. No.: US 2005/0156470 A1
(43) Pub. Date: Jul. 21, 2005

(54) Electric motor comprising a stator cooling unit

(76) Inventors: Bernd Gromoll, Baiersdorf (DE); Norbert Huber, Erlangen (DE)

Correspondence Address: STAAS & HALSEY LLP, SUITE 700, 1201 NEW YORK AVENUE, N.W., WASHINGTON, DC, 20005, US

(21) Appl. No.: 10/516,955

(22) PCT Filed: May 26, 2003
(86) PCT No.: PCT/DE03/01705

(30) Foreign Application Priority Data
Jun. 6, 2002 (DE) 10225224.6
Apr. 17, 2003 (DE) 10317967.4

(51) Int. Cl. H02K 9/00

(52) U.S. Cl. 310/52; 310/58

(57) ABSTRACT

A fixed stator is arranged around a rotatably mounted rotor in an electric motor that includes at least one cooling unit to which parts of the stator which are to be cooled are thermally coupled by a line system in which a cooling agent circulates according to a thermosyphon effect. The stator parts to be cooled can be arranged in the inner region of a stator housing which is integrated into the line system. The electric motor can be provided with a heating device to maintain the pressure in the inner region when the motor is stopped.

This application is based on and hereby claims priority to German Application No. PCT/DE03/01705 filed on May 26, 2003 and German Patent Applications 102252224.6 filed Jun. 6, 2002 and 10317967.4 filed Apr. 17, 2003, the contents of all of which are hereby incorporated by reference.

### BACKGROUND OF THE INVENTION

1. Field of the Invention

The invention relates to an electrical machine having] a rotor which is mounted such that it can rotate,] an associated, stationary stator, and] a device for cooling at least the stator or parts of it.

2. Description of the Related Art

A corresponding machine is disclosed in EP 0 853 370 A1.

A considerable amount of heat may be developed in the stator of machines or motors, particularly with relatively high power levels, and this has to be dissipated by cooling measures in order to achieve higher machine efficiency. By way of example, air-cooled generators (in particular with ratings below 300 MVA) are known, in which cooling is achieved by a comparatively large air flow which is passed through a network of finer channels (see the EP-A1 document cited initially). In this case, however, the air flow itself contributes to undesirable heat being produced to a considerable extent, as a consequence of friction losses in the channels.

For relatively large machines such as generators, it is also known for the stator and rotor to be cooled with hydrogen gas (see, for example “Proceedings of the American Power Conference”, Volume 39, Chicago 1977, pages 255 to 269), which is circulated in an encapsulated housing. In this case, not only are complex sealing measures required, but extensive safety measures also have to be taken into account.

Furthermore, water-cooled generators are also standard, in which the water is circulated in channels which, in particular, extend through the so-called stator bars (and laminated stator cores). The use of pumps is necessary for this purpose.

Furthermore, the water must be conditioned, for corrosion protective reasons.

### SUMMARY OF THE INVENTION

An object of the present invention is therefore to refine the machine with the features mentioned initially so as to allow effective cooling with relatively little complexity.

According to the invention, this object is achieved by the cooling device for the machine having at least one cold surface of a refrigeration unit to which the parts of the stator to be cooled are thermally coupled via a line system, in which a circulation of a coolant is provided or is carried out on the basis of a thermosiphon effect.

A line system such as this has at least one closed pipeline, which runs between the cold surface of a refrigeration unit and the parts of the stator to be cooled, with a gradient. The coolant which is located in this line system in this case recondenses on the cold surface of the refrigeration unit, and is passed from there into the area of the stator parts to be cooled, where it is heated and, in the process, generally vaporized. The coolant, which is thus generally vaporized, then flows within the line system back again into the area of the cold surface of the refrigeration unit. The corresponding circulation of the coolant accordingly takes place on the basis of a so-called “thermosiphon effect” in a natural circulation with boiling and vaporization. Thus, according to the invention, this principle which is known per se is applied to the cooling of stator parts of power electrical machines.

In comparison to air-cooled machines, this allows the air volume flow to be reduced by partial direct heat dissipation at the point where the heat losses are generated, via a thermosiphon. This results in a reduction in the development of heat that is produced by the air flow, which allows a further reduction in the air volume flow. This thus results in higher machine efficiency and savings in production costs, in particular for the winding and the laminated core of the stator.

If the stator is cooled completely by thermosiphoning, the power limit beyond which hydrogen cooling is normally used instead of air cooling is shifted to considerably higher power ranges.

In comparison to direct water cooling of stator windings with forced circulation, the advantages are as follows:
No corrosion or complex conditioning of the coolant when using organic coolants such as butane, propane or acetone.
There is no risk of fire or explosion, owing to the use of a closed line system.
Furthermore, the cooling device is maintenance-free, does not contain any pumps or other moving mechanical parts, and is, furthermore, self-regulating.

The advantages associated with the refinement of the machine according to the invention are thus that the power range from which direct stator cooling is worthwhile can be reduced.

The cold surface can thus be arranged in a simple manner on or in a condenser area, which is integrated in the line system.

Furthermore, at least one coolant area can advantageously be integrated in the line system, in which stator parts to be cooled make a large-area thermally conductive connection with the coolant, between which and the stator parts to be cooled good heat exchange is ensured.

The internal area of a stator housing can particularly advantageously be provided as a coolant area in which at least the majority of the parts of the stator to be cooled are arranged. This internal area is in consequence in the form of an integrated part of the thermosiphon line system. This is based on the assumption that the majority of the stator parts to be cooled include more than 50% of the volume of the parts of the stator which are heated without cooling, in particular such as the winding and, possibly, laminated cores for carrying the magnetic flux. In this context, a stator housing is the housing which fixes the internal area with the stator parts to be cooled and with the coolant which cools them. The advantages of this refinement of the machine are mainly that the heat-generating parts of the stator are at least largely subjected to the coolant, as heat exchanging surfaces, thus ensuring correspondingly good heat absorption by the coolant.

The stator parts to be cooled in the internal area advantageously make a large-area thermally conductive connection with the coolant. In this case, the stator parts to be cooled may also include laminates of a laminated core, in addition to a stator winding. Since heat is likewise produced in laminates such as these during operation, this can effectively be transferred to the coolant.

Furthermore, the stator of the machine may have cooling channels, which are integrated in the line system. Cooling channels such as these are particularly advantageous for the operation of the thermosiphon when the stator is arranged vertically (with the rotor axis running vertically), since any coolant vapor that is then produced can flow away well.

Furthermore, in order to assist the heat dissipation, the cooling device may also have flow paths for air cooling.

In addition, it may be regarded as particularly advantageous for a heating apparatus to be provided on or in the line system, in an area in which the coolant is at least largely in the liquid state. Specifically, a heating apparatus such as this makes it possible to reduce or compensate for undesirable pressure differences between the stator internal area, which is filled with the coolant, and the surrounding outside area when the machine is stationary (=shutdown in operation). This is because, when the machine is stationary, the stator generates virtually none of the heat that results in the heating of the coolant. This means that the internal area of the stator housing is cooled ever further owing to the cooling power which is introduced via the coolant as before, so that the pressure falls well below the environmental pressure. In conjunction with low external temperatures and material shrinkage, such a reduced pressure could result in leaks in the stator housing, via which air could be sucked in. This would lead to the boiling line of the coolant that is used being shifted, thus in the long time rendering the thermosiphon circuit ineffective. This risk can be precluded by using the special heating apparatus. This is because the heating apparatus makes it possible to prevent the stationary pressure falling below the environmental pressure in the stated area, preferably in an end-face area of the stator. The supply of heat results in the coolant being vaporized even when the machine is stationary. The corresponding vapor then condenses at cold points in that part of the thermosiphon line system which is formed by the stator internal area, where it thus heats the line system to a largely uniform temperature. This is associated with a pressure rise in the line system, corresponding to the boiling characteristic of the coolant that is used. In this case, the heating power can advantageously be regulated via a pressure sensor, so as to set a pressure at least equal to the environmental pressure in the line system. Since virtually no power losses occur during a shutdown in operation, the heating apparatus has to compensate only for the convective losses via the stator housing to the environment.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a combined perspective and block diagram showing stator cooling by a vaporizer cooler for a machine,

FIG. 2 is a block diagram showing direct stator cooling by discrete cooling channels within a stator housing of the machine,

FIG. 3 is a block diagram showing a further refinement of the machine, with a coolant area in a stator housing, and

FIG. 4 is a graph of the temperature-dependent pressure ratios in the coolant in the machine shown in FIG. 3.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

The electrical machine according to the invention is based on machines which are known per se in the higher power range, such as generators. Parts which are not illustrated are generally known. Only those parts of the machines which are significant to the invention are shown in the figures.

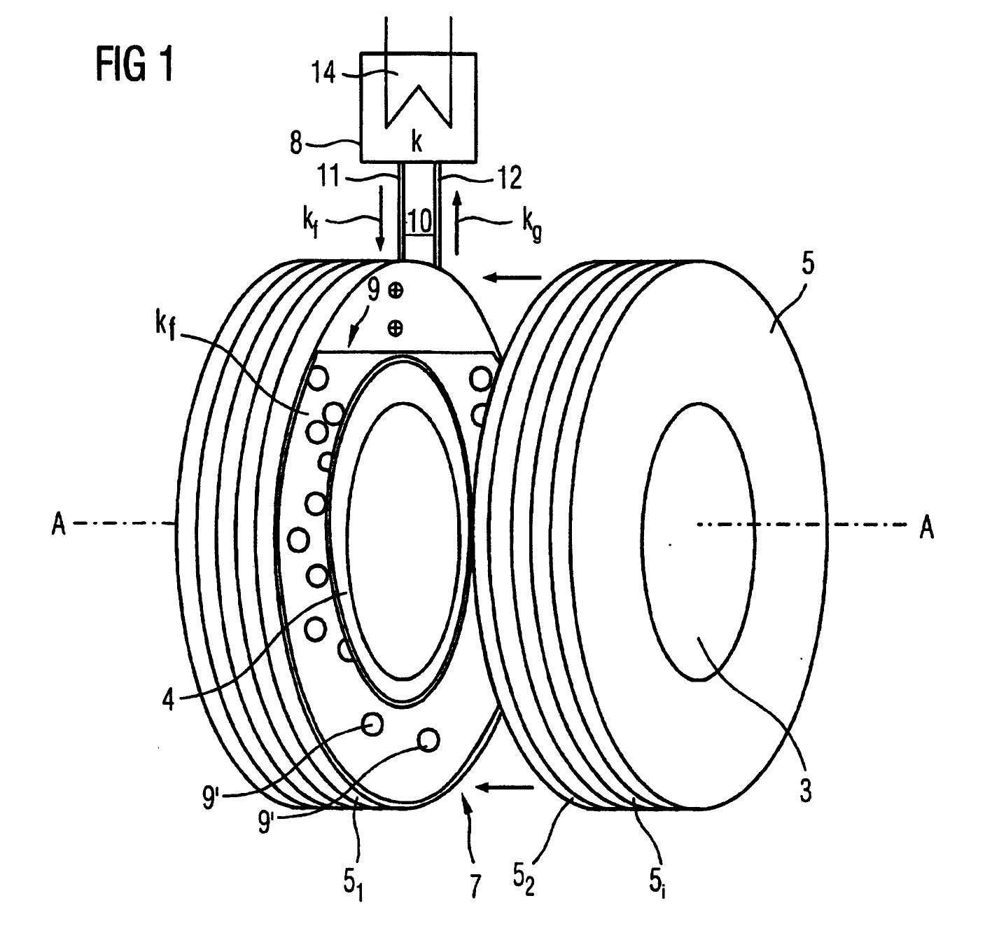

According to FIG. 1, the machine 2 has a cooled or uncooled rotor 3, which is mounted such that it can rotate about an axis A. The rotor is at least partially surrounded by a stator 5 while maintaining an intermediate space 4 with an annular cross section, of which stator 5 in FIG. 1 illustrates only individual laminates 5ᵢ of a laminated core. A coolant area 7 in the form of a disk is formed between two of these laminates 5₁ and 5₂, which are in the form of disks and are illustrated exploded axially in FIG. 1. Corresponding coolant areas are integrated or stacked and/or pushed in into the laminated core at specific intervals (seen in the axial direction). This ensures there are large heat exchanging surface areas between a coolant k which is located in the at least one coolant area, and the adjacent laminates of the laminated core 5.

Depending on the requirement for the temperature level to be chosen, liquefiable gases such as propane, butane, acetone or neon, or azeotropic mixtures that are used in standard refrigeration technology, may be used as the coolant.

In design terms, the at least one coolant area 7 can be produced advantageously in the following manner, specifically
by two laminates which are separated by spacers and are welded together in a pressure tight manner along the edges,
or by the use of elements which are held at a distance from one another by the introduction of beads.

The at least one coolant area 7 is part of a closed line system 10 for the coolant k circulating in it. At a geodetically higher level, the line system contains a condenser area 8, which is connected to the coolant area 7 between the stator laminates 51 and 52 via a coolant supply line 11 and a coolant return line 12.

The refrigeration power for cooling of the stator is provided by a refrigeration device, which is not illustrated in any more detail but which, for example, has at least one cold head located at its cold end. A cold head such as this has a cold surface 14 which is of any desired shape but must be kept at a predetermined temperature level, or is thermally connected to such a cold surface 14. The internal area of the condenser chamber 8 and thus the coolant are thermally coupled to this cold surface; for example, the cold surface 14 may also form a wall of this area.

The coolant condenses on the cold surface 14 and, as a result of the geodetic grading, passes in liquid form (which is annotated k_{f}) via the supply line 11 into the coolant area 7 in the area of the laminated stator core 5 to be cooled. The coolant level there is annotated 9. There, the coolant is heated, for example being at least partially vaporized, as is intended to be indicated by individual vapor bubbles 9′ in FIG. 1. The coolant k_{g} which is thus gaseous, flows out of this area 7 via the return line 12 into the condenser area 8, where it recondenses on the cold surface 14. A natural circulation such as this with boiling and vaporization forms the thermosiphon principle (see also DE 41 08 981 C2 or DE 100 18 169 A1).

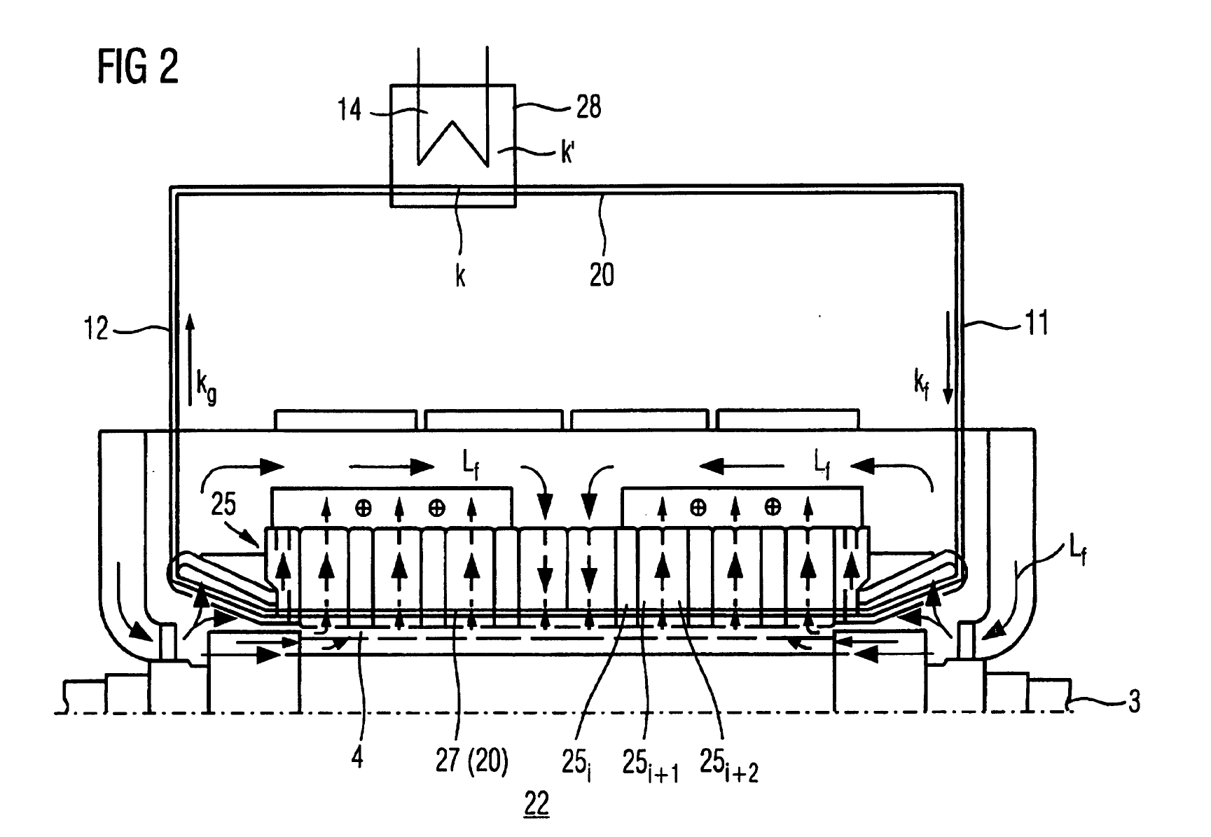

A combination of air cooling with thermosiphon cooling of its stator 25 is provided for the electrical machine 22, which is illustrated only partially in the form of a section in FIG. 2. In this case, the air circulates in a known manner (see, for example, EP 0 853 370 A1, which was cited in the introduction, or EP 0 522 210 A1), and is illustrated by lines Lf with arrows on them. In addition, cooling channels 27 of a line system 20 run in the axial direction through the core of the stator laminates 25ᵢ. At the ends, these cooling channels once again open into a coolant supply line 11 and a coolant return line 12. These lines 11 and 12 are connected to a condenser area 28 with a cold surface 14 for cooling down the coolant which is circulated in the line system 20 using a thermosiphon effect and is in general annotated k. The lines 11 and 12 either open into this area, in which condensation of gaseous coolant k_{g} then takes place to form liquid coolant k_{f}. Alternatively, as is assumed for the exemplary embodiment, indirect cooling is provided by a further coolant k′, which fills the area 28. In this case, the line system 20 runs through this area where heat is exchanged with the coolant k′ through the wall of the line system. Thus, in this embodiment, instead of being subjected to forced circulation coolant by water, the stator bars and laminates 25ᵢ are in this embodiment cooled in a closed circuit with a thermodynamically advantageous coolant k, which is matched to the operating state (pT), with the laminates 25ᵢ together with their cooling channels 27 being used as vaporizers. Owing to the two separate lines 11 and 12, the thermosiphon line system 20 is also referred to as a “two-pipe thermosiphon”.

The exemplary embodiments which have been explained with reference to the figures advantageously use a number of vaporizer coolers which are optionally either connected by individual cooling circuits to the condenser area, or whose supply and return lines are in the form of joint lines. The advantage in this case is the smaller pipework complexity, in which case it is necessary for the individual vaporizers to ensure that the coolant flows are split on the basis of the thermal requirement. Owing to the large amount of heat transferred during condensation, the physical volume for cooling down and thus the costs are reduced by the use of the thermosiphon cooling in comparison to air/air cooling or air/water cooling.

In contrast to the provision of the cooling power, as assumed for the embodiments shown in FIGS. 1 and 2, by the cold head of a gryogenenic cooling at a relatively low temperature level, it is possible, particularly when comparatively higher operating temperatures are permissible, for a coolant to be cooled down on a cold surface by water or environmental air, as well. This is because the only precondition for circulation of the corresponding coolant based on the thermosiphon effect is the temperature gradient between the cold surface of a refrigeration unit and the stator parts to be cooled.

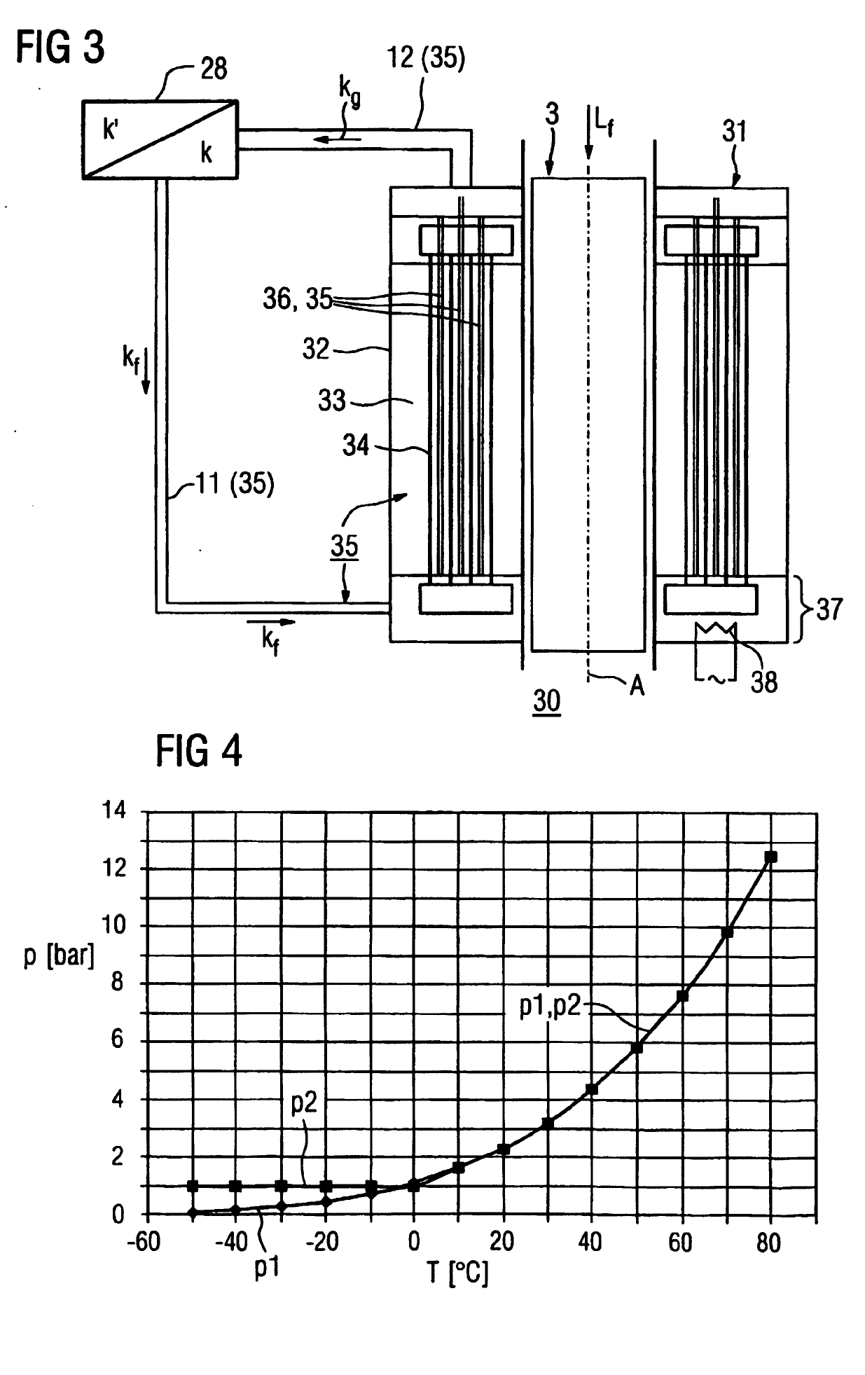

A further exemplary embodiment of a machine according to the invention with a particular refinement of the thermosiphon line system for its cooling device is illustrated schematically, in the form of a section, in FIG. 3. In this case, this FIG. 3 essentially shows only the configuration of a refrigeration device. The machine, which is annotated in general 30, contains a stator 31 with a stator housing 32 which surrounds an internal area 33, which is sealed on the outside. At least the majority of the stator parts to be cooled are intended to be located in this internal area. A stator winding 34, which is known per se, together with further stator parts, in particular for retaining or holding the winding, and for guiding the magnetic flux, such as laminated cores, are accordingly accommodated in the internal area 33. The internal area 33 is advantageously in the form of an integrated part of a thermosiphon line system 35, whose method of operation corresponds to the method of operation of the line system 20 described with reference to FIG. 2. When the machine is in operation, the liquid coolant k_{f} supplied via the supply line 11 absorbs heat that is produced by the stator parts to be cooled, and is vaporized in the process. In order to improve the dissipation of the vaporized, gaseous coolant k_{g}, particularly if the machine or its axis A is arranged vertically, cooling channels or pipes 36 may also run through the stator parts to be cooled. In this case, pipes 36 which project above the filling level are advantageous for a vertical arrangement, as is the basis of FIG. 3, since vapor which is produced in the lower part of the housing can be dissipated well upwards via them.

When the machine 30 is stationary, corresponding heat sources are largely absent. An electrical heating apparatus 38 can therefore advantageously be associated with the thermosiphon line system 35 in an area which the liquid coolant k_{f} coming from a condenser area 28 enters. This area 37 may preferably be located on the end face of the stator 31, or possibly also at a point on the coolant supply line 11 at which the coolant k_{f} is still in the liquid state. This heating apparatus allows the coolant to be additionally heated, preferably vaporized, so that this results in a pressure increase in the internal area 33, starting from the area 37. This means that this heating apparatus can be used to regulate the pressure in this area. The heating power for setting the pressure is in this case controlled using known techniques which may, in particular, include the use of pressure sensors.

One exemplary embodiment of a corresponding pressure increase is indicated in the graph in FIG. 4 for the coolant with the item designation “R236fa”. In this case, the temperature T of the coolant is plotted in the abscissa direction in the area 37 (measured in ° C.), and the pressure p in the coolant (measured in bar=10⁵ Pa) is plotted in the ordinate direction. As can be seen from the graph, the heating apparatus 38 according to the invention can be used to produce a pressure increase/to regulate the pressure at −40° C., the temperature of the liquid coolant k_{f} that is supplied, of, for example, about 0.1 bar to about 1.0 bar at this temperature. A pressure increase such as this is preferably planned when the rotor 3 of the machine 30 is stationary and there is a risk of excessive cooling of the stator 31 with a pressure drop in its internal area 33. The curve p1 on the graph describes the pressure relationships which would occur in the internal area of the stator without additional heating power from the heating apparatus when the rotor is stationary. In this case, the curve p1 represents the boiling line of the chosen coolant. The pressure relationships illustrated by the curve p2 are obtained with the heating apparatus switched on, and allow an increase to the environmental pressure around the stator housing 32 to, for example, 1 bar. In this case, the amount of additionally heating power introduced into the coolant is expediently only as much as is required to compensate for the pressure differences between the internal pressure in the line system and the environmental pressure.

The heating apparatus according to the invention can also, of course, be used to provide additional heating power during rotation of the rotor, if the heat generation caused in the interior by the stator parts to be cooled is not sufficient.

The embodiment of the machine 30 illustrated in FIG. 3 is based on the assumption that the heating apparatus 38 is located exclusively in the end-face area 37 of the stator 31. Arrangement of this heating apparatus in this area is admittedly regarded as particularly advantageous, since heating of the coolant, which is generally still liquid when entering the stator, takes place in any case there. It is, of course, also possible for the heating apparatus to extend—seen in the flow direction of the coolant—from the end-face area into axial areas of the stator internal area or of the line system as well, if the coolant there is still in the liquid state. However, if required, the heating apparatus 38 may also be fitted to the supply line 11, upstream of the inlet area of the liquid coolant kf into the stator.

In general, an electrically heated apparatus 38 is provided directly on or in the thermosiphon line system. However, if required, the heating power can also be introduced into the coolant in some other manner, for example indirectly via a heat exchanger.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-10. (canceled)

11. An electrical machine, comprising:
a rotor rotatably mounted;
a stator associated with said rotor in a stationary position; and
a cooling device, cooling at least parts of said stator, including
a refrigeration unit having at least one cold surface; and
a closed line system, thermally coupling said refrigeration unit to the parts of said stator to be cooled, having discrete coolant areas associated with the parts of said stator to be cooled, and in which a coolant is circulated by a thermosiphon effect, the coolant being heated or at least partially vaporized in the discrete coolant areas.

12. The machine as claimed in claim 11, further comprising a condenser area where said closed line system is thermally coupled to the cold surface of said refrigeration unit.

13. The machine as claimed in claim 12, wherein the discrete coolant areas are thermally conductively connected over a large area to the stator parts to be cooled.

14. The machine as claimed in claim 13,
wherein said stator has a laminated core, and
wherein the discrete coolant areas are formed between laminates of the laminated core of said stator.

15. The machine as claimed in claim 12, wherein the discrete coolant areas are formed as cooling channels.

16. The machine as claimed in claim 15, further comprising flow paths for air cooling.

17. The machine as claimed in claim 11, wherein the discrete coolant areas are thermally conductively connected over a large area to the stator parts to be cooled.

18. The machine as claimed in claim 17,
wherein said stator has a laminated core, and
wherein the discrete coolant areas are formed between laminates of the laminated core of said stator.

19. The machine as claimed in claim 11, wherein the discrete coolant areas are formed as cooling channels.

20. The machine as claimed in claim 19, further comprising flow paths for air cooling.
